(19) United States
(12) Patent Application Publication
(10) Pub. No.: US 2015/0330480 A1
(43) Pub. Date: Nov. 19, 2015

(54) Process for Engaging or Disengaging Splined Members

(71) Applicant: CATERPILLAR SHREWSBURY LIMITED, Shrewsbury (GB)

(72) Inventor: Craig Wynne, Shrewsbury (GB)

(73) Assignee: CATERPILLAR SHREWSBURY LIMITED, Shrewsbury (GB)

(21) Appl. No.: 14/709,070

(22) Filed: May 11, 2015

(30) Foreign Application Priority Data
May 16, 2014 (GB) 1408754.8

(51) Int. Cl. F16H 3/66; F16H 63/02; F16H 1/10

(52) U.S. Cl. CPC F16H 3/66; F16H 1/10; F16H 63/02; F16H 2200/0034; F16H 2200/2094

(57) ABSTRACT

This disclosure relates to a process for at least one of engaging and disengaging splined members in a vehicle system. The process includes applying an axial reciprocating motion to one splined member and applying an oscillatory motion to another splined member such as a gear. This enables the splined member to be moved at least one of into and out of engagement with the gear.

### CROSS-REFERENCE TO RELATED APPLICATIONS

This patent application claims the benefit of United Kingdom Patent Application No. 1408754.8, filed May 16, 2014, which is incorporated by reference.

### TECHNICAL FIELD

This disclosure relates to a process for engaging or disengaging splined members in a vehicle system.

### BACKGROUND

It is often necessary to provide further gearing between the engine and the wheels of a vehicle in addition to the main gearbox or the transmission system. A final drive may be configured to provide multiple speed ranges to assist the vehicle during various operations such as travelling, digging, loading etc. The vehicle may have a gear selector to select one of the multiple speed ranges in the final drive assembly. For example, in a low speed ratio the vehicle may operate at a slow speed with high torque, for example during digging, earth moving, and the like. Alternatively, in a high speed ratio the vehicle may operate at a higher speed, for example during travel.

Tracked vehicles often utilise two gear ratios, a high ratio for travelling speeds and a low ratio for working speeds.

A typical final drive assembly may include a compound gear set comprising a pair of coupled epicyclic gear sets to selectively engage the final drive in one of the multiple speed ranges. A switching assembly may be provided to switch between the ratios by engaging one or both of the epicyclic gear sets. The switching assembly may be external to the final drives and operatively coupled to the epicyclic gear sets via a complex mechanism. The switching assembly may comprise a ratio change device (sometimes termed a “ratio change sleeve”) to affect the switch.

EP-A-1506912 describes a two speed planetary final drive in which a ratio (range) change device is movable between a low ratio position, a high ratio position and a neutral position. To change the gear ratio, the ratio change device in the planetary gearing system is moved in an axial direction to engage different gear sets. More particularly, the splines of the ratio change device are moved to engage either the splines of a first gear or splines of a second gear.

### SUMMARY OF THE DISCLOSURE

According to the present disclosure there is provided a process for engaging or disengaging a splined member and at least one engaging gear in a vehicle system, the splined member having a splined surface for engaging a splined surface of the at least one engaging gear, wherein the splined member is movable in an axial direction into or out of engagement with the at least one engaging gear, the process comprising:

applying an axial reciprocating motion to the splined member;

applying an oscillatory motion to the at least one engaging gear; and

moving the splined member into or out of engagement with the at least one engaging gear.

The present disclosure further provides a two speed final drive for a vehicle comprising:

a first epicyclic gear set;

a second epicyclic gear set;

an input shaft engaged with the first epicyclic gear set;

a ratio change device comprising at least one splined surface configured to move into or out of engagement with a splined surface of at least one engaging gear of the first and or second epicyclic gear set during a ratio change process;

actuation means for applying an axial reciprocating motion to the ratio change device;

actuation means for applying an oscillatory motion to the at least one engaging gear, said actuation means comprising the input shaft; and

control means for controlling the ratio change process such that the axial reciprocating motion and oscillatory motion are continued until the engagement or disengagement is complete.

### BRIEF DESCRIPTION OF THE DRAWINGS

Preferred embodiments of the process of the present disclosure are described with reference to the accompanying drawings, in which:

FIG. 1 is a schematic of a two-speed final drive in a low ratio position;

FIG. 2 is a schematic of the two-speed final drive of FIG. 1 in a high ratio position; and

FIG. 3 is a perspective sectional view illustrating a portion of a ratio change device of the two-speed final drive of FIG. 1.

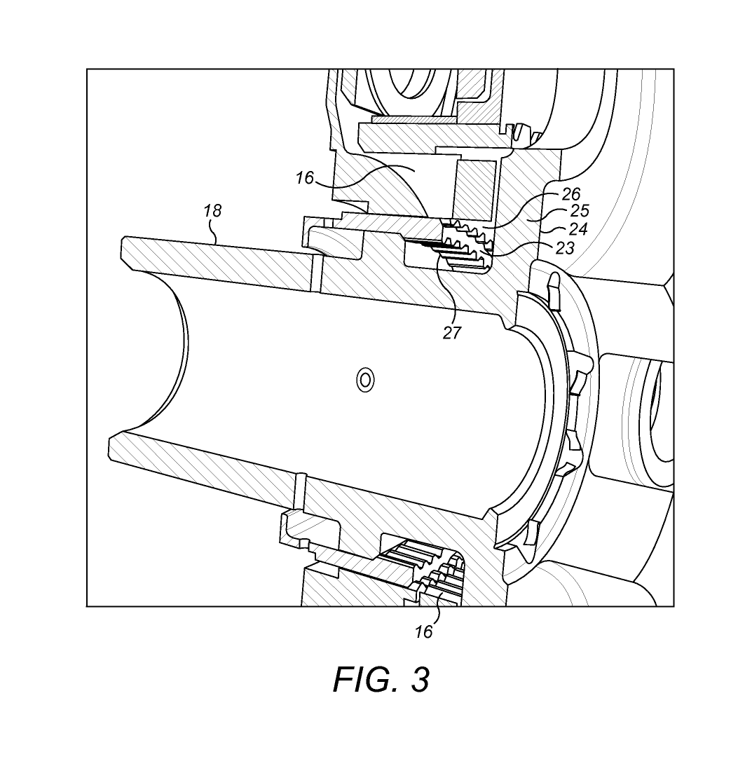

### DETAILED DESCRIPTION

The process of the present disclosure may be used in any mechanism or application in which two splined members are engaged or disengaged. It is particularly suitable for use in a ratio change process for changing the gear ratio of a two speed final drive of a vehicle, and in particular of a two speed final drive configured to enable the vehicle to operate in a high speed ratio and a low speed ratio. By way of illustration only the process is described herein with reference to a ratio change process for changing the gear ratio of a two speed final drive of a vehicle. It will be appreciated that the engagement/disengagement process described herein may be used for any other gear change or gear ratio change mechanism.

A two speed final drive may comprise a compound gear set comprising coupled epicyclic gear sets (i.e. a first epicyclic gear set coupled to a second epicyclic gear set). To change the gear ratio, a ratio change device may be moved in an axial direction to engage and/or disengage one or more gears of one or both at the epicyclic gear sets. A gear with which the ratio change device moves into engagement will be referred to herein as an “engaging gear”. Similarly a gear with which the ratio device moves out of engagement will be referred to herein on a “disengaging gear”. The ratio change device may also disengage with one or more gears of one or both of the epicyclic gear sets.

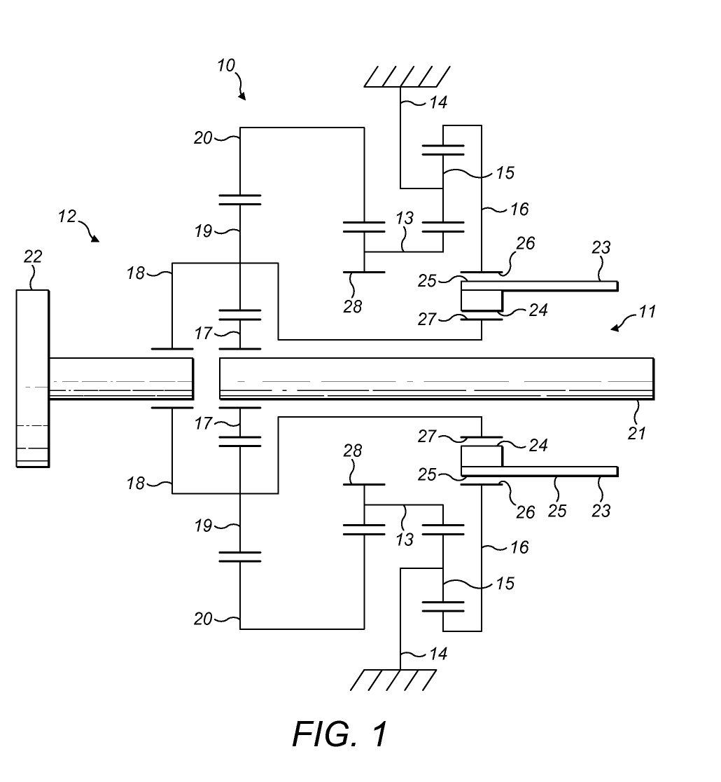

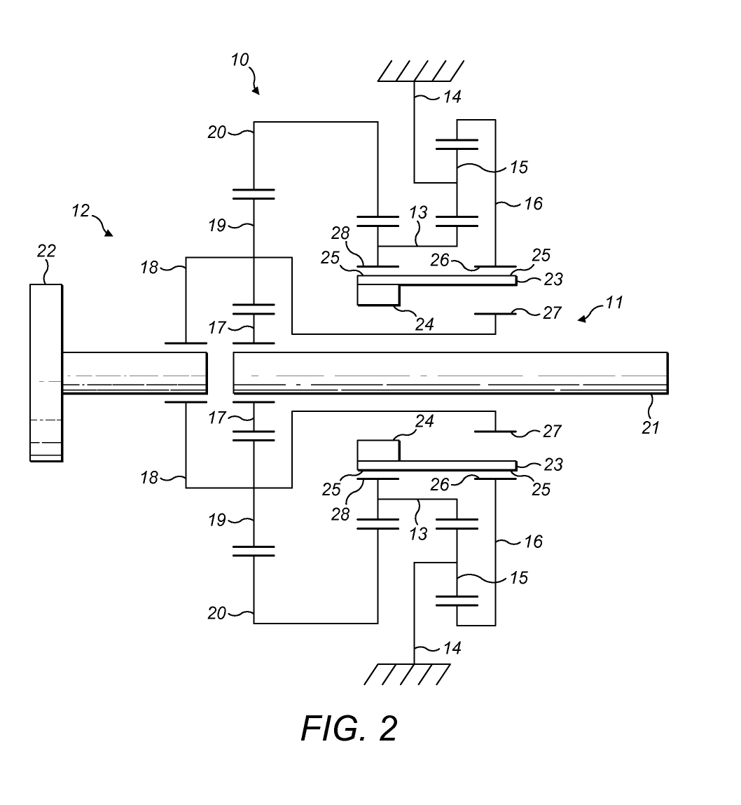

A known final drive for a tracked vehicle is described in EP-A-1506912 and the basic construction of such a final drive is suitable for use with the control system of the present disclosure. Schematics of a compound gear set 10 for such a final drive are shown in FIGS. 1 and 2.

The compound gear set 10 may comprise a first epicyclic gear set 11 (also known as a star set) and second epicyclic gear set 12 (also known as a planet set). The first epicyclic gear set 11 may have a first sun gear 13, first planet carrier 14, a plurality of first planet gears 15 and a first ring gear 16. The second epicyclic gear set 12 may comprise a second sun gear 17, a second planet carrier 18, a plurality of second planet gears 19 and a second ring gear 20.

The first sun gear 13 may have an inner splined surface 28; the first ring gear 16 may have an inner splined surface 26; and the second planet carrier 18 may have an outer splined surface 27.

The first sun gear 13 and second ring gear 20 may be rotatably coupled together. It will be understood that “rotatably coupled” means that coupled components rotate at the same speed. The rotational coupling may also be achieved by any suitable method and may be, for example, by a spline connection or by using a unitary sun gear and ring gear component.

An input shaft 21 may be mounted within the final drive and rotatably coupled to the second sun gear 17.

The first planet carrier 14 may be permanently grounded so that it cannot rotate. The second planet carrier 18 may be rotatably coupled to an output shaft 22.

An oscillatory motion, such as a precess motion, may be applied to the engaging gear during the ratio change process by means of the input shaft 21 such that the engaging gear oscillates with a clockwise and anti-clockwise motion. The movement of the input shaft 21 may be controlled by a precess steer unit, which may comprise one or more shaft actuators or another suitable mechanism. The shaft actuators may be hydraulic, electrohydraulic or hydraulic/mechanical actuators which may be controlled by a valve system, which may comprise electro-hydraulic valves. The valve system may be hydraulically and/or electronically coupled to an interface device located in an operator cab of the vehicle. The oscillatory motion may be applied to a transmission steer unit, which in turn causes the oscillatory motion of the engaging gear. However any suitable mechanism may be used depending on the application in which the process is used.

A splined member, in this example a ratio change device 23, may be mounted around the input shaft 21. Splines may be present on the ratio change device 23 so that an inner splined surface 24 and an outer splined surface 25 may be provided. The splined surfaces 24,25 may extend only along a portion of the splined member. The ratio change device 23 may slide along the input shaft 21, the movement of which may be controlled by one or more device actuators or another suitable mechanism. The device actuators may be hydraulic, electrohydraulic or hydraulic/mechanical actuators which may be controlled by a valve system, which may comprise electro-hydraulic valves. The valve system may be hydraulically and/or electronically coupled to an interface device located in an operator cab of the vehicle. One example of a mechanism for controlling the movement of a ratio change device is described in GB1319146.5, which is hereby incorporated by reference. However any suitable mechanism may be used depending on the application in which the process is used.

The ratio change device 23 may have three positions: a low ratio position, a high ratio position and a neutral position. The ratio change process is affected by moving the ratio change device 23 from one position to another. As it moves, one or more of its splined surfaces 24,25 may engage and/or disengage with a splined surface 26,27,28 of at least one gear 16,18,13.

The low ratio position is shown in FIG. 1. In this position the inner splined surface 24 of the ratio change device 23 may interlock with the outer splined surface 27 of the second planet carrier 18 (this is one engaging gear) and the outer splined surface 25 of the ratio change device may interlock with the inner splined surface 26 of the first ring gear 16 (this is another engaging gear). Since the second planet carrier 18 is rotatably coupled to the output shaft 22, the first ring gear 16 may rotate at the same speed as the output shaft 22. Furthermore, since the first planet carrier 14 is permanently grounded and cannot rotate, the first planet gears 15 may cause the first sun gear 13 to rotate, which in turn may cause the second ring gear 20 to rotate. The second planet gears 19 may rotate around the rotating second ring gear 20. This may reduce the rotational speed of the second planet carrier 18 and consequently the rotational speed of the output shaft 22. Thus both the first and second epicyclic gear sets 11,12 may rotate to some degree in low ratio.

The high ratio position is shown in FIG. 2. In this position the outer splined surface 25 of the ratio change device 23 may interlock with both the inner splined surface 26 of the first ring gear 16 (one engaging gear)and the inner splined surface 28 of the first sun gear 13 (another engaging gear). This may lock the first sun gear 13 to the first ring gear 16 and maintain them stationary. Since the first planet carrier 14 is permanently grounded and does not rotate, the first epicyclic gear set 11 may not rotate at all in high ratio. The second ring gear 20 may also be stationary since it is rotatably coupled to the first sun gear 13. High ratio is determined only by the second epicyclic gear set 12.

If the ratio change device 23 is moved from the low ratio position to the high ratio position the second planet carrier 18 is a disengaging gear. If the ratio change device 23 is moved from the high ratio position to the low position, the first sun gear 13 is a disengaging gear.

In the neutral position (not shown) the ratio change device 23 may be in a position between the high ratio and low ratio positions and disengages with all the gears 13,16,18 (these will all be disengaging gears), which effectively disconnects the input shaft 21 from the output shaft 22.

A control system may be used to effect the ratio change process. The control system may provide two control mechanisms. In the first control mechanism, an oscillatory motion, such as a precess motion, is applied to the engaging/disengaging gear during the ratio change process. The precess motion may take form of a sinusoidal varying of amplitude with time. The sinusoidal precess motion may allow a predetermined transition time period between the clockwise and anticlockwise rotational engagement of the splines 26,27,28 of the engaging/disengaging gear with the splines 24,25 of the ratio change device 23. This transition time period may provide a zero load time period, in which the ratio change device 23 can axially engage/disengage the engaging/disengaging gear(s). The transition time period is selected so as to allow a sufficient zero load time period for the engagement or disengagement. The amplitude of the precess motion may increase from zero as a function of time such that the rotational distance traversed by the engaging/disengaging gear increases.

The second control mechanism may apply an axial reciprocating motion to the ratio change device 23 during its engagement/disengagement with the engaging/disengaging gear(s). The amount of force imparted by the device actuators to the ratio change device 23 may be varied in a pulse like manner, so that the ratio change device 23 reciprocates in a forward axial direction (i.e. the direction in which the ratio control device 23 moves to engage with the engaging gear) and a reverse axial direction. A greater magnitude of force may be applied in the forward axial direction (push) compared the reverse axial direction (pull). The push time may be greater than the pull time for example the push time may be 1 second and the pull time may be 0.1 second. When male parts of the splines 24,25,26,27,28 of both the ratio change device 23 and the engaging gear(s) meet in a head on manner, the pulse-action intermittently reduces axial loading so that the male parts of the splines 24,25,26,27,28 can more easily pull away from their head-on positions and so that the splines 24,25,26,27,28 can successfully engage with one another. Reciprocation of the ratio change device 23 may be achieved by controlling the ratio change hydraulic actuators so as to move the ratio change device 23 repetitively in and out of the desired ratio. The ratio change device 23 may have to travel 50 mm to move into a new ratio position. The range of pulsing movement may be considerably less than this, for example 20 mm.

The control system may comprise a driveline control module (DCM). A change of the final drive ratio is a predefined procedure which may only be effected when a valid ratio change request is received, for example when the operator selects a different gear ratio via a selector switch.

The control system may be programmed with a precess-pulse loop which controls the precess and reciprocating motions, such that the relevant gear is first steered left (which corresponds to the top half of the sine wave); the ratio change device is reciprocated; the relevant gear is then steered right (which corresponds to the bottom half of the sine wave); and the ratio change device is again reciprocated. The oscillatory (precess) and reciprocating motions may be applied simultaneously or consecutively.

The rate of the oscillatory/precess motion, governed by the travel of a spline of the relevant gear to and from a central zero load position, may be independently configurable and a rate shaping function may be used to control the steer position overshoot during precess. The frequency of precess cycle may be up to a maximum of 0.5 Hz. In other examples, the frequency of the osillation/precess cycle may be greater than 0.5 Hz, for example, the oscillation/precess cycle may have a frequency selected from a range of 0.5 to 1 Hz.

The control system may be programmed with an initial steer precess target (i.e. a rotational distance of travel by the relevant gear when the gear is precessed), which may be incremented until the ratio change is successful. A maximum value for the steer precess target may be preset. The steer precess target may be 20% of the full range of steer or less. The steer precess target may be stored in non-volatile memory to speed up subsequent ratio changes.

The control system may be programmed to control the ratio change device reciprocating motion, which may be modulated during a steer precess to induce a ‘tremor’. The frequency of reciprocation cycles may be in the range from 10 milliseconds to 2 seconds. The number of reciprocation cycles or a time period may be used to determine when the pulsing is to be turned off. The reciprocating in and out periods may be independently configurable.

The control system may be programmed to allow a predetermined number of “precess-pulse” loops or a predetermined time period of application of the oscillatory/axial reciprocating motions, before cancelling the process change request and reverting to the original ratio position. A predetermined time period for a successful ratio change may be 30 seconds.

The control system may also be programmed to determine whether a number of other conditions relating to the vehicle are satisfied before allowing operation of the ratio change process. These conditions may be some or all of the following:
the engine is switched on;
the transmission gear is in neutral;
the steering lever is centered;
the secondary braking system is engaged;
neither the service or parking brakes are engaged;
there is no pressure applied to the accelerator pedal, i.e. the engine is idling;
the vehicle is stationary; and
the oil temperature in the final drive is above a predetermined limit.

### INDUSTRIAL APPLICABILITY

The process is particularly suitable for a vehicle system such as the final drive of a tracked or other vehicle which must be able to operate at both low torque, high speed and high torque, low speed conditions, for example in earth moving applications. A two speed final drive may be used for each of the tracks of a twin tracked vehicle, making possible the use of a conventional multi-speed transmission as the primary transmission.

The two speed final drive may be switched into a high speed ratio, a neutral ratio, and a low speed ratio. The high speed ratio may be required for operation of the vehicle while travelling on-road and off-road. The low speed ratio may be required for operation of the vehicle whilst performing operations such as digging, earth moving and the like. In neutral ratio no torque is transmitted from the two speed final drive to the vehicle. Hence the neutral ratio may be engaged when the vehicle is receiving torque/power from external sources such as, but not limited to, towing of the vehicle.

The high speed ratio, the low speed ratio and the neutral ratio at the driven shaft 22 are achieved though the second epicyclic gear set 12, both the first and second epicyclic gear sets 11, 12, and neither of the first or the second epicyclic gear sets 11, 12 respectively.

The high speed ratio, the low speed ratio and the neutral ratio may be selected by the operator through a selector switch. The selector switch activates the control system, which in turn controls the positioning of the ratio change device 23. When the operator selects the high speed or low speed ratio through the selector switch, the control system checks that the conditions are met for operation of the drive change process. If the conditions are met, the ratio change device actuators may be energised and a monitoring process started. The ratio change device 23 may be reciprocated initially in an attempt to drive the ratio change device 23 straight into the interlock with the appropriate engaging gears (s) for the new ratio. If this is unsuccessful then the engaging gear(s) is(are) precessed or subjected to another oscillatory motion. The precess-pulse loop or the simultaneous oscillatory/axial reciprocation motions may be repeated until interlock with the engaging gear(s) is achieved. When the interlock is achieved, the monitoring process will signal the control system to reflect that the new ratio that has been achieved.

1. A process for at least one of engaging and disengaging a splined member and at least one engaging gear in a vehicle system, the splined member having a splined surface for engaging a splined surface of the at least one engaging gear, wherein the splined member is movable in an axial direction at least one of into and out of engagement with the at least one engaging gear, the process comprising:
applying an axial reciprocating motion to the splined member;
applying an oscillatory motion to the at least one engaging gear; and
moving the splined member at least one of into and out of engagement with the at least one engaging gear.

2. A process as claimed in claim 1 in which the axial reciprocating motion and oscillatory motion are applied simultaneously.

3. A process as claimed in claim 1 in which periods of axial reciprocating motion and oscillatory motion are repeated consecutively.

4. A process as claimed in claim 1 in which the oscillatory motion is in a clockwise and anticlockwise direction.

5. A process as claimed in claim 1 in which the oscillatory motion is a sinusoidal precess motion.

6. A process as claimed in claim 5 in which an amplitude of the oscillatory motion increases from zero as a function of time.

7. A process as claimed in claim 1 in which a greater magnitude of force is applied to the splined member in at least one of an engagement and disengagement axial direction, in which it moves to at least one of engage with and disengage from the at least one engaging gear, than in a reverse axial direction.

8. A process as claimed in claim 1 in which a force is applied for a greater period of time to the splined member in at least one of an engagement and disengagement axial direction, in which it moves to at least one of engage with and disengage from the at least one engaging gear, than a period of time in which a force is applied in a reverse axial direction.

9. A process as claimed in claim 1 in which a limit is set on a number of repeats of axial reciprocating motion and oscillatory motion before cancelling the process.

10. A process as claimed in claim 1 in which a time limit is set for repeats of the axial reciprocating motion and oscillatory motion before cancelling the process.

11. A process as claimed in claim 1 in which a frequency of reciprocation cycles of the axial reciprocating motion lies in a range of 10 milliseconds to 2 seconds.

12. A process as claimed in claim 1 in which each period of axial reciprocating movement comprises a predetermined number of reciprocation cycles of the reciprocating motion.

13. A process as claimed in claim 1 in which each period of axial reciprocating movement has a predetermined duration.

14. A process as claimed in claim 1, further comprising changing a ratio of a two speed final drive of a vehicle, the two speed final drive comprising at least a first epicyclic gear set, a second epicyclic gear set and a ratio change device, in which the splined member comprises the ratio change device and the at least one engaging gear comprises a gear of at least one of the first and second epicyclic gear set.

15. A process as claimed in claim 1, further comprising controlling the process with a control system.

16. A two speed final drive for a vehicle comprising:
a first epicyclic gear set;
a second epicyclic gear set;
an input shaft engaged with the first epicyclic gear set;
a ratio change device comprising at least one splined surface configured to move at least one of into and out of engagement with a splined surface of at least one engaging gear of at least one of the first and second epicyclic gear set during a ratio change process;
actuation means for applying an axial reciprocating motion to the ratio change device;
actuation means for applying an oscillatory motion to the at least one engaging gear, said actuation means comprising the input shaft; and
control means for controlling the ratio change process such that the axial reciprocating motion and oscillatory motion are continued until at least one of engagement and disengagement is complete.

17. A process as claimed in claim 2 in which the oscillatory motion is in a clockwise and anticlockwise direction.

18. A process as claimed in claim 2 in which the oscillatory motion is a sinusoidal precess motion.

19. A process as claimed in claim 18 in which an amplitude of the oscillatory motion increases from zero as a function of time.

20. A process as claimed in claim 2 in which a greater magnitude of force is applied to the splined member in an at least one of engagement and disengagement axial direction, in which it moves to at least one of engage with and disengage from the at least one engaging gear, than in a reverse axial direction.
